(19) United States
(12) Patent Application Publication
(10) Pub. No.: US 2020/0316668 A1
(43) Pub. Date: Oct. 8, 2020

(54) METHOD OF MANUFACTURING PRESS FORMED PRODUCT

(71) Applicant: TOA Industries Co., Ltd., Ota-shi (JP)

(72) Inventors: Taichi SHIMIZU, Midori-shi (JP); Tadashi IWANUMA, Isesaki-shi (JP)

(73) Assignee: TOA Industries Co., Ltd., Ota-shi (JP)

(21) Appl. No.: 16/828,247

(22) Filed: Mar. 24, 2020

(30) Foreign Application Priority Data
Apr. 4, 2019 (JP) 2019-071803

(51) Int. Cl. B21D 22/20; B21D 35/00; B23K 26/22

(52) U.S. Cl. CPC B21D 22/208; B23K 2101/18; B23K 26/22; B21D 35/007

(57) ABSTRACT

The invention provides a method of manufacturing a press formed product which reduces the welding time and enhances the productivity. First, a main steel plate and a reinforcement steel plate are bonded by laser welding a superposed portion of the main steel plate and the reinforcement steel plate to form a superposed blank member. This superposed blank member is heated to higher temperature than the austenite transformation temperature to transform the superposed blank member into austenite. The superposed blank member transformed into austenite is then press formed and rapidly cooled with dies at the same time to be transformed into martensite, thereby forming a press formed product.

### CROSS-REFERENCE OF THE INVENTION

This application claims priority from Japanese Patent Application No. 2019-71803, filed Apr. 4, 2019, the content of which is incorporated herein by reference in its entirety.

### BACKGROUND OF THE INVENTION

### Field of the Invention

The invention relates to a method of manufacturing a press formed product, particularly, a method of manufacturing a press formed product including a process of performing hot press forming to a superposed blank member.

### Description of the Related Art

Japanese Patent Application Publication No. 2014-193712 describes a method of manufacturing a press formed product which is partially reinforced with a reinforcement steel plate and has high tensile strength by superposing the reinforcement steel plate on a main steel plate, spot-welding the superposed portion to bond both the steel plates to form a superposed blank member, and performing hot press forming to the superposed blank member.

In general, hot press forming is to press form and rapidly cool a steel plate heated to higher temperature than the austenite transformation temperature with dies at the same time. By the hot press forming, a steel plate is quenched and strengthened by a rapid cooling effect with dies at the same time as the press forming, thereby largely enhancing the tensile strength of the steel plate.

However, the technique described in Japanese Patent Application Publication No. 2014-193712 has a problem of long welding time and low productivity since both the steel plates are bonded by spot-welding the superposed portion. There is also a problem in the spot-welding that the bonding strength and stiffness are insufficient due to the point bonding of the superposed blank member.

### SUMMARY OF THE INVENTION

To address the problems described above, a method of manufacturing a press formed product includes forming a superposed blank member by bonding a main steel plate and a reinforcement steel plate by continuously laser welding the main steel plate and the reinforcement steel plate at a superposed portion thereof, heating the superposed blank member to a temperature higher than an austenite transformation temperature to transform the superposed blank member into austenite, and forming a press formed product by press forming and rapidly cooling the superposed blank member transformed into austenite with dies so as to transform the superposed blank member into martensite.

### BRIEF DESCRIPTION OF THE DRAWINGS

FIG. 1 is a drawing of a process of manufacturing a press formed product in an embodiment of the invention.

FIGS. 2A to 2D are plan views showing waveform welding patterns.

FIGS. 3A to 3D are plan views showing modifications of the waveform welding patterns.

FIGS. 4A to 4D are plan views showing other types of welding patterns than the waveforms.

FIGS. 5A to 5D are plan views showing still other types of welding patterns.

FIG. 6 is a plan view showing a superposed member (a pillar reinforcement) formed by laser welding.

### DETAILED DESCRIPTION OF THE INVENTION

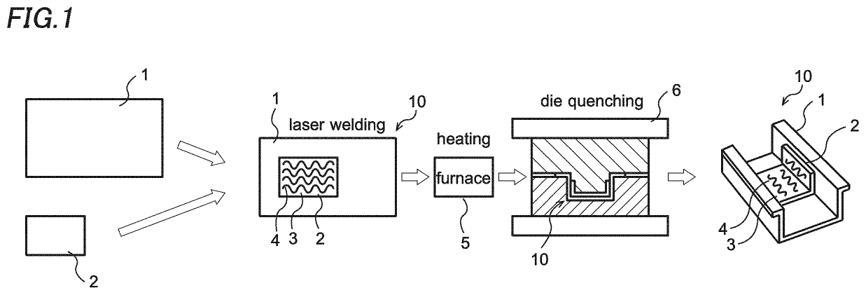

A method of manufacturing a press formed product of an embodiment of the invention will be described referring to FIG. 1, hereafter.

First, a reinforcement steel plate 2 is superposed on a main steel plate 1. The reinforcement steel plate 2 is disposed on the main steel plate 1 in a region where the tensile strength is to be enhanced partially, and in the embodiment the reinforcement steel plate 2 is entirely included in the main steel plate 1 in the plan view. In this case, the main steel plate 1 and the reinforcement steel plate 2 are pressed with jigs and closely attached.

The reinforcement steel plate 2 on the main steel plate 1 is then laser welded by a laser processing machine. The laser processing machine is well known, and configured by, for example, connecting a laser oscillator to a laser processing head through optical fibers. A laser beam generated by the laser oscillator is outputted from the laser processing head.

In this process, the superposed portion 3 is irradiated with a laser beam from above the reinforcement steel plate 2, and the laser beam moves along a predetermined route. Both the steel plates are then melted and bonded by the heat of the laser beam, thereby forming a superposed blank member 10. The output power of the laser oscillator is about 4 KW for the thickness 1 mm of each of both the steel plates, for example, although it differs depending on the thickness of the steel plate. The irradiated region with a laser beam is circle in the resting state, the diameter is about 0.5 to 1.0 mm, and the moving speed is about 3 to 8 m/min. A welding pattern 4 is formed by the laser beam irradiation. The welding pattern 4 is a planar pattern in the welded portion, and the details will be described below.

The superposed blank member 10 is then disposed in a furnace 5 and heated to higher temperature than the austenite transformation temperature, thereby transforming the metallographic structure of the superposed blank member 10 into austenite. The austenite transformation temperature is 870° C., for example, although it differs depending on the carbon content of the steel plate.

The superposed blank member 10 transformed into austenite is then taken out from the furnace 5 and set in dies 6, and press formed and rapidly cooled from higher temperature than the ferrite transformation start temperature (Ar3) with the dies 6 at the same time. By this, the metallographic structure of the superposed blank member 10 is transformed into martensite, and quenched and strengthened.

This process is referred to as hot press forming, die quenching, hot stamping and the like. The dies 6 are then opened, and a press formed product made of the superposed blank member 10 is taken out.

The press formed product (the superposed blank member 10) thus manufactured enhances the tensile strengths of the main steel plate 1 and the reinforcement steel plate 2 to 1.5 Gpa or more, respectively, and also provides the superposed portion 3 with higher strength.

Accordingly, in the method of manufacturing a press formed product of the embodiment, the superposed blank member 10 is formed by bonding both the steel plates by laser welding the superposed portion 3, so that the welding time is reduced compared with the spot-welding to enhance the productivity. In addition, the bonding area of the superposed blank member 10 is increased, thereby enhancing the bonding strength and stiffness.

In this case, the welding pattern 4 formed by laser beam irradiation is generally a linear pattern along a moving route. Extending this welding pattern 4 over the entire superposed portion 3 provides a bonding state that is substantially close to surface bonding, thereby further enhancing the bonding strength and stiffness.

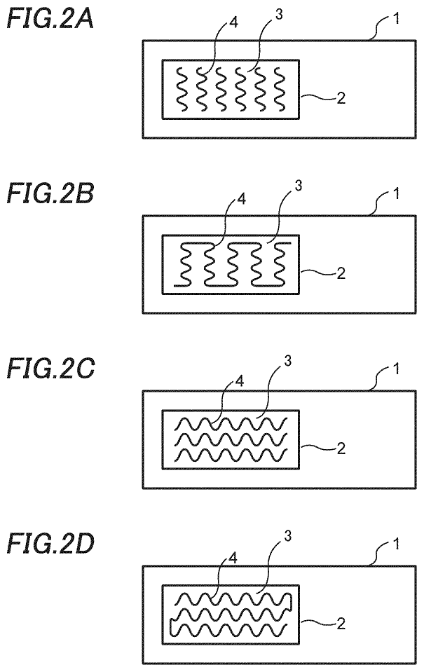

Next, examples of the welding pattern 4 formed by laser beam irradiation will be described referring to figures. As shown in FIG. 2A to 2D, the reinforcement steel plate 2 is superposed on the main steel plate 1, and a waveform welding pattern 4 is formed on the superposed portion 3. Such a waveform of the welding pattern 4 extends the bonding area planarly on the superposed portion 3 in the vertical and horizontal directions. This welding pattern 4 is disposed over the entire superposed portion 3.

Each of the welding patterns 4 in FIGS. 2A to 2D is formed of a plurality of waveforms arrayed in the vertical or horizontal direction. Each of the welding patterns 4 in FIGS. 2B and 2D has a single start point and a single end point and is formed by connecting these start and end points to form a line. This is a so-called continuous line pattern. This enables the continuous irradiation of a laser beam rather than the intermittent irradiation, thereby further reducing the welding time. The start and end points of the welding pattern 4 may be different or the same.

While each of the welding patterns 4 in FIGS. 2A and 2C is also a continuous line pattern, it differs in that each of the welding patterns 4 in FIGS. 2B and 2D is formed of a single continuous line extended over the entire superposed portion 3 by the continuous irradiation of a laser beam.

That is, while each of the welding patterns 4 in FIGS. 2A and 2C is formed of a plurality of continuous lines formed in the superposed portion 3, each of the welding patterns 4 in FIGS. 2B and 2D is formed of a single continuous line formed in the superposed portion 3.

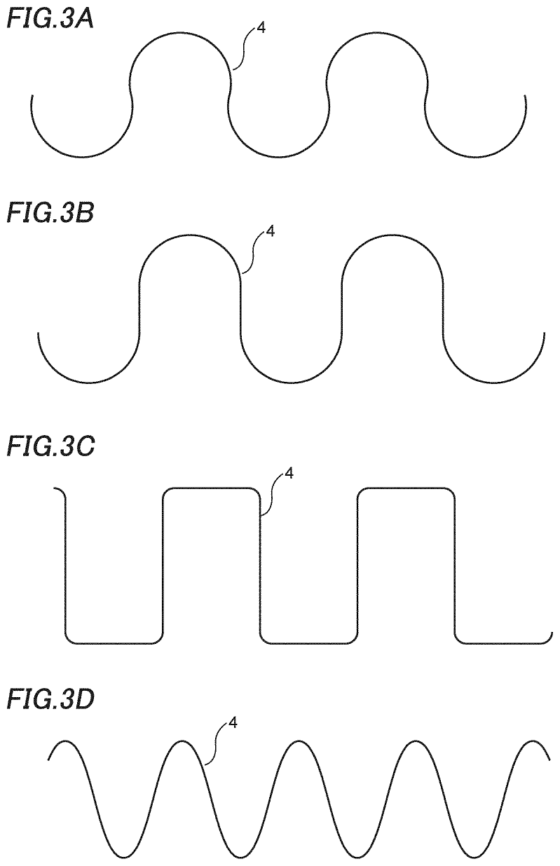

FIGS. 3A to 3D are drawings showing modifications of the waveform welding pattern 4. A welding pattern 4 in FIG. 3A is formed of repeated upward and downward arcs connected into a waveform. A welding pattern 4 in FIG. 3B is formed of repeated arcs and straight lines connected into a waveform. A welding pattern 4 in FIG. 3C is a square wave. A welding pattern 4 in FIG. 3D is a sine wave pattern. Each of these welding patterns of modification is also disposed over the entire superposed portion 3 by the continuous irradiation of a laser beam or may also form a single continuous line pattern.

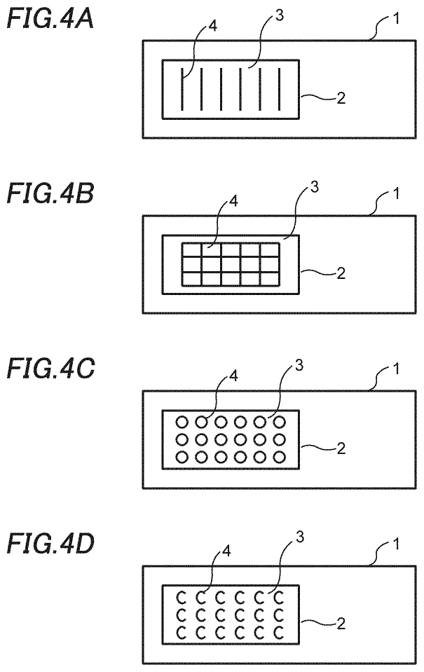

FIGS. 4A to 4D are drawings showing other types of welding patterns 4 other than the waveforms. A welding pattern 4 in FIG. 4A is basically a straight line pattern, and is formed of a plurality of straight lines arrayed parallel. A welding pattern 4 in FIG. 4B is a lattice pattern formed of crossed vertical and horizontal straight lines. A welding pattern 4 in FIG. 4C is basically a ring pattern, and is formed of a plurality of rings arrayed in the vertical and horizontal directions. The ring pattern includes various types of ring (loop) shapes which are circle, oval, polygonal and so on.

A welding pattern 4 in FIG. 4D is basically an arc pattern, and is formed of a plurality of arcs arrayed in the vertical and horizontal directions. In this case, “an arc” includes a portion of a circle such as a circular arc. These types of welding patterns are also disposed over the entire superposed portion 3.

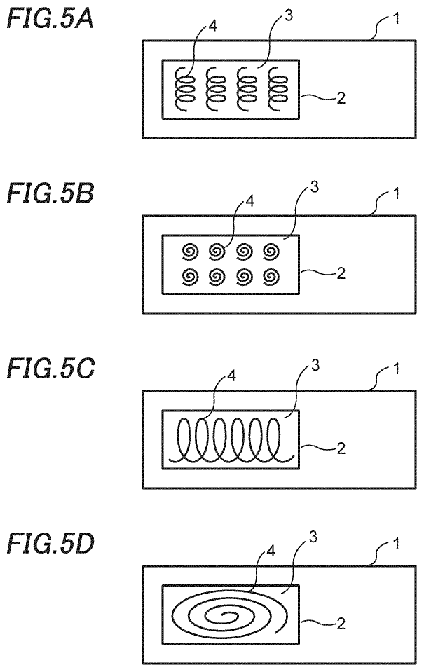

FIGS. 5A to 5D are drawings showing still other types of welding patterns 4. A welding pattern 4 in FIG. 5A is formed of a plurality of spirals arrayed. A welding pattern 4 in FIG. 5B is formed of a plurality of whorls arrayed. A welding pattern 4 in FIG. 5C is formed of a single spiral disposed over the entire superposed portion 3. This is a single continuous line pattern. A welding pattern 4 in FIG. 5D is also formed of a single whorl disposed over the entire superposed portion 3. This is also a single continuous line pattern.

The manufacturing method described above is suitably applicable to a center pillar provided vertically on the side portion of the body of a vehicle, for example. The center pillar is a vehicle member configured so as to have a pillar reinforcement between a pillar outer panel and a pillar inner panel. The pillar reinforcement partially enhances the tensile strength of a region at height corresponding to an occupant's breast.

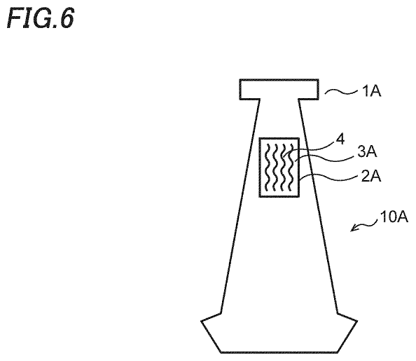

As shown in FIG. 6, a superposed blank member 10A for forming this pillar reinforcement is formed by superposing a reinforcement steel plate 2A on a main steel plate 1A in a corresponding region and laser welding this superposed portion 3A. In this case, a laser welding process and subsequent heating and die quenching processes performed to the superposed blank member 10A are as described above.

What is claimed is:

1. A method of manufacturing a press formed product, comprising:
forming a superposed blank member by bonding a main steel plate and a reinforcement steel plate by continuously laser welding the main steel plate and the reinforcement steel plate at a superposed portion thereof;
heating the superposed blank member to a temperature higher than an austenite transformation temperature to transform the superposed blank member into austenite; and
forming a press formed product by press forming and rapidly cooling the superposed blank member transformed into austenite with dies so as to transform the superposed blank member into martensite.

2. The method of claim 1, wherein the continuous laser welding of the main steel plate and the reinforcement steel plate forms a welding pattern of a line shape.

3. The method of claim 1, wherein the welding pattern is a continuous line pattern formed by connecting a single start point and a single end point.

4. The method of claim 3, wherein only one continuous line pattern is formed in the superposed portion.

5. The method of claim 2, wherein the welding pattern comprises a waveform pattern.

6. The method of claim 2, wherein the welding pattern comprises a straight line pattern.

7. The method of claim 2, wherein the welding pattern comprises a ring pattern.

8. The method of claim 2, wherein the welding pattern comprises an arc pattern.

9. The method of claim 2, wherein the welding pattern comprises a spiral pattern.

10. The method of claim 2, wherein the welding pattern comprises a whorl pattern.
